(19) United States
(12) Patent Application Publication
(10) Pub. No.: US 2010/0129567 A1
(43) Pub. Date: May 27, 2010

(54) METHOD FOR MANUFACTURING INFORMATION RECORDING MEDIUM

(76) Inventors: Masahiko Tsukuda, Osaka (JP); Morio Tomiyama, Nara (JP)

Correspondence Address: WENDEROTH, LIND & PONACK L.L.P., 1030 15th Street, N.W., Suite 400 East, Washington, DC, 20005-1503, US

(21) Appl. No.: 12/594,883

(22) PCT Filed: Feb. 4, 2009
(86) PCT No.: PCT/JP2009/000428

§ 371 Date: Oct. 6, 2009

(30) Foreign Application Priority Data
Feb. 6, 2008 (JP) 2008-026161

(51) Int. Cl. G11B 7/26

(52) U.S. Cl. 427/558; 427/256

(57) ABSTRACT

A problem has been the pronounced build-up of resin layers in the innermost peripheral region and/or the outermost peripheral region, which are the ends of the coating region, that occurs when layers of resin are applied over intermediate resin layers that have been cured. In an inkjet coating method, the ratio of the amount of resin dropped in the innermost peripheral coating region (102) and the outermost peripheral coating region (104) to the amount dropped in an intermediate coating region adjacent to these is set to be the greatest in the resin layer applied adjacent to the substrate (101) out of the plurality of resin layers, or to be the same as the other resin layers.

### TECHNICAL FIELD

The present invention relates to a method for manufacturing an information recording medium used for the purpose of reproduction, or recording and reproduction, and comprising stacked curable resin layers, and more particularly relates to a method for manufacturing an information recording medium having a plurality of information layers.

### BACKGROUND ART

Research has been conducted into optical information recording methods in recent years, and these methods have come to be used in a wide range of industrial and consumer applications. In particular, optical information recording media with which information can be recorded at high density, such as CDs and DVDs, have become very popular. These optical information recording media have a transparent substrate, an information layer, and a protective layer. The transparent substrate has an information face consisting of a bumpy surface, such as guide grooves for tracking recording and reproduction light, or pits that represent an information signal. The information layer is formed from a metal thin film, or a thin film material that allows thermal recording, or the like that is formed over the transparent substrate. The protective layer is formed on the information layer, and consists of a transparent substrate, a resin layer, or the like that protects against moisture in the atmosphere and so forth. Information is reproduced by shining a laser beam on the information layer and detecting the changes in the amount of light that is reflected.

In the case of a CD, for example, first an information layer is formed by laminating a metal thin film, a thin film material, or the like over a resin substrate that is approximately 1.1 mm thick and has an information face composed of bumps on one side. This is then coated with a radiation curable resin, typified by a UV curable resin or the like, to form a protective layer. A CD is produced in this way. To reproduce an information signal, a laser beam is directed not from the protective layer side, but from the substrate side.

In the case of a DVD, an information layer is formed by laminating a metal thin film, a thin film material, or the like over an information face composed of bumps on a resin substrate that is approximately 0.6 mm thick, after which a separately prepared resin substrate with a thickness of approximately 0.6 mm is affixed with a UV curable resin or the like to produce the DVD.

There is a growing need for higher capacity in such optical information recording media, and to this end multiple layers have been used for the information layer in DVDs and the like, and there have been proposals, for example, for optical information recording media with a two-layer structure in which an information layer sandwiches an intermediate with a thickness of a few dozen microns.

Also, as digital high-definition broadcasts have become more common in recent years, there has been a need for a next-generation optical information recording medium with higher density and larger capacity than a DVD. For instance, there have been proposals for large-capacity media such as the Blu-ray Disc, in which an information layer is formed by laminating a metal thin film or the like over an information face composed of bumps on a substrate with a thickness of 1.1 mm, and a protective layer with a thickness of approximately 0.1 mm is formed over the information layer. With a Blu-ray Disc, the track pitch of the information layer is narrower and the size of the pits is smaller than with a DVD. Accordingly, the laser spot used to record and reproduce information has to be focused more tightly on the information layer. With a Blu-ray Disc, a special optical head is used to focus the laser beam spot on the information layer. This optical head makes use of a blue-violet laser with a short wavelength of 405 nm, and the objective lens used to focus the laser beam has a numerical aperture (NA) of 0.85. However, when the spot is smaller, the effect of disk tilt tends to be greater, and if the disk tilts even a little, there will be astigmatism in the beam spot, which produces distortion in the focused beam and precludes recording and reproduction. Therefore, with a Blu-ray Disc this drawback is compensated for by reducing the thickness of the protective layer on the side of the disk where the laser is incident to about 0.1 mm.

Nevertheless, even with a next-generation optical information recording medium that has large capacity, such as a Blu-ray Disc, there have been proposals to increase the storage capacity by using multiple information layers, just as with a DVD.

FIG. 12 is a cross section of a two-layer Blu-ray Disc in which there are two information layers.

This two-layer Blu-ray Disc has a molded resin substrate 201, a first information layer 203, a resin intermediate layer 204, a second information layer 206, and a protective layer 207. The first information layer 203 and second information layer 206 are composed of a thin film material that allows for thermal recording, or a metal thin film. The resin intermediate layer 204 and protective layer 207 are composed of a resin that is substantially transparent with respect to the recording and reproduction light.

A first information face 202 consisting of bumps is formed on the molded resin substrate 201. The first information layer 203 is laminated over the first information face 202. The resin intermediate layer 204 is formed over the first information layer 203. A second information face 205 consisting of bumps is formed over the resin intermediate layer 204. The second information layer 206 is laminated over the second information face 205. The protective layer 207 covers the second information layer 206.

The term “substantially transparent” as used here means having transmissivity of at least about 90% with respect to the recording and reproduction light, and “semitransparent” means having transmissivity of at least 10% and no more than 90% with respect to the recording and reproduction light.

With this two-layer Blu-ray Disc, the laser beam is incident from the protective layer 207 side, and is focused on either the first or second information layer, whichever is the information layer where recording and reproduction are to be performed, and this allows signals to be recorded and reproduced, etc.

The thickness of the molded resin substrate 201 is set to approximately 1.1 mm, the thickness of the resin intermediate layer 204 to approximately 25 μm, and the thickness of the protective layer 207 to approximately 75 μm.

A multilayer Blu-ray Disc such as this is generally manufactured by the following method. As an example, a method for manufacturing a two-layer Blu-ray Disc will be described here.

FIG. 13 shows the steps for producing a stamper, which is a metal die for producing the molded resin substrate of an information recording medium. First, a photosensitive film 302 is produced by coating a base 301 consisting of a glass plate, a silicon wafer, or the like with a photoresist or another such photosensitive material, and a laser beam, an electron beam, or another such exposure beam 303 is used to expose a pattern such as pits or guide grooves (FIG. 13a). This forms a latent image composed of an exposed part 304 (FIG. 13b). The exposed part 304 is then removed with an alkali developing solution or the like to obtain a recording base 306 comprising a bump pattern 305 formed by a photosensitive material on the base 301 (FIG. 13c). A conductive thin film 307 is formed on the surface of this recording base 306 by sputtering, vapor deposition, or another such method (FIG. 13d). This conductive thin film 307 is used as an electrode to form a metal sheet 308 by metal plating or the like (FIG. 13e). The conductive thin film 307 and the metal sheet 308 are then separated at the interface between the photosensitive film 302 and the conductive thin film 307. Any photosensitive material remaining on the surface of the conductive thin film 307 is removed with a stripper or the like. Finally, punching is performed to the inside and outside diameters dictated by the molding machine. As a result, a metal stamper 309 is produced (FIG. 130.

Next, a resin substrate is formed by a resin molding method such as injection molding using the metal stamper 309. A material such as polycarbonate with excellent moldability is usually used as the substrate material. After this, resin layers are laminated using a resin layer formation process involving spin coating or the like as discussed in Patent Document 1, for example.

FIG. 14 shows the steps for producing a two-layer disk, and comprises steps of producing a resin intermediate layer and a protective layer by spin coating.

A molded resin substrate 401 is formed by a resin molding method such as injection molding using a metal stamper. The molded resin substrate 401 has on one side a first information face formed by guide grooves or pits consisting of a bumpy surface, and has a thickness of approximately 1.1 mm. Then, a first information layer 402 is formed over the first information face by sputtering, vapor deposition, or another such method from a thin film material that allows thermal recording, or a metal thin film. The molded resin substrate 401 on which the first information layer 402 has been formed is fixed on a rotary stage 403 by vacuum chucking or another such method (FIG. 14a). The first information layer 402 on the molded resin substrate 401 that has been fixed to the rotary stage 403 is coated with a radiation curable resin A 404 from a dispenser and in a concentric pattern of the desired radius (FIG. 14b). The rotary stage 403 is then spun to spread out the radiation curable resin A 404 and form a resin layer 406 (FIG. 14c). The thickness of the resin layer 406 at this point can be controlled as desired by suitably adjusting the viscosity of the radiation curable resin A 404, the spinning speed, the spinning duration, and the ambient atmosphere in which the spinning is performed (such as its temperature and humidity). After the spinning is stopped, the resin layer 406 is cured by radiation from a radiation emitter 405.

Next, a transfer stamper 407 for forming a second information face is formed by injection molding using the metal stamper shown in FIG. 13f. This transfer stamper 407 is fixed by vacuum chucking or the like onto a rotary stage 408. The transfer stamper 407 placed on the rotary stage 408 is coated with a radiation curable resin B 409 from a dispenser and in a concentric pattern of the desired radius (FIG. 14d). The rotary stage 408 is then spun to spread out the radiation curable resin B 409 and form a resin layer 411 (FIG. 14e). The thickness of the resin layer 411 can be controlled as desired as described above. After the spinning is stopped, the resin layer 411 is cured by radiation from a radiation emitter 410.

Next, the molded resin substrate 401 and the transfer stamper 407 on which the resin layers 406 and 411 have been respectively formed are put together so that the resin layers 406 and 411 are opposite each other, and with a radiation curable resin C 412 interposed between them (FIG. 140. The radiation curable resin C is spread out by spinning a rotary stage 413 in this integrated state. After the formation of a resin layer 414 that has been adjusted to the desired thickness, this is irradiated with radiation from a radiation emitter 415 to cure the resin layer 414 (FIG. 14g). After the molded resin substrate 401 and the transfer stamper 407 have been integrated by the resin layer 414, the transfer stamper 407 is removed from the interface between the transfer stamper 407 and the resin layer 411, which forms a second information face on the molded resin substrate 401 (FIG. 14h). A second information layer 416 is formed over this second information face by sputtering, vapor deposition, or another such method from a thin film material that allows thermal recording, or a metal thin film. After this, a radiation curable resin D is applied by the same spin coating method and subjected to radiation curing, which forms a protective layer 417 (FIG. 14i). In some cases, another layer such as a hard coating layer for preventing defects in the protective layer surface due to scratches or fingerprints may be formed over the protective layer. This completes a two-layer Blu-ray Disc.

The radiation curable resin A 404 used here is a material that has good adhesion to the first information layer 402 and the resin layer 414, and the material of the resin layer 411 is one that will readily separate from the transfer stamper 407 and has good adhesion to the resin layer 414. These radiation curable resins A, B, C, and D are resins that are substantially transparent to the wavelength of the recording and reproduction light. Also, what was described here was the process of producing a resin intermediate layer using three types of radiation curable resin, but there is also a simpler method in which the number of types of radiation curable resin is reduced by controlling the separability from the radiation curable resin and the like by proper selection of the transfer stamper material, and so forth.

Also, as shown in Patent Document 2, a four-layer information recording medium has been proposed that has four information recording layers. With a four-layer information recording medium, the thickness of the various resin intermediate layers must be varied to minimize the effect of interference from other layers. With spin coating, as discussed above, the desired thickness can be obtained by suitably adjusting the viscosity of the radiation curable resin, the spinning speed, the spinning duration, and the ambient atmosphere in which the spinning is performed (such as its temperature and humidity). Accordingly, spin coating has generally been the method employed to form resin layers of different thickness as in a four-layer information recording medium.

Patent Document 1: Japanese Laid-Open Patent Application 2002-092969

Patent Document 2: Japanese Laid-Open Patent Application 2004-213720

### DISCLOSURE OF INVENTION

Nevertheless, when a resin intermediate layer is formed by spin coating, the following problems are encountered, mainly due to factors such as that the resin is supplied only to a certain region, or that the centrifugal force used for spreading varies with the radial position. In other words, it is difficult to form a radiation curable resin layer with a uniform thickness, and the resin ends up reaching all the way to the outer peripheral end face of the molded resin substrate, so the effect of surface tension at the end face causes the resin layer to build up at the outermost peripheral part.

Also, when spin coating is used, applying one coating of radiation curable resin takes somewhere around 10 seconds, and this is one of the things that lowers production efficiency in the manufacture of a multilayer information recording medium. Also, with spin coating, since the resin layers are formed while part of the resin dropped onto the substrate is spun off, more resin has to be dropped than is actually necessary for the information recording layers that are to be formed on the substrate. Consequently, the resin that is spun off either ends up being wasted, or has to be reused after going through an additional process such as recycling. This is another factor in reducing productivity.

Furthermore, in the manufacture of a multilayer information recording medium having three or four information layers, or in the formation of protective layers, coatings are applied over the information recording layers that have been formed before. Accordingly, when a coating is applied over a resin intermediate layer that has already been cured, the applied resin does not conform as well as when the coating is applied to the substrate. In particular, the contact angle is larger, and there is pronounced build-up of the resin layer at the innermost peripheral region or the outermost peripheral region (the ends of the coating region).

It is an object of the present invention to produce a plurality of resin layers having different thicknesses, and to manufacture a multilayer information recording medium having good signal characteristics, without reducing productivity.

A coating method involving an inkjet method in which non-contact coating can be performed, without requiring any special mask or the like in the desired coating region, is proposed as one means for solving these problems.

The method for manufacturing an information recording medium pertaining to the present invention is a method for manufacturing an information recording medium produced by the lamination of a substrate, a plurality of information layers, and a plurality of resin layers of different thickness that separate the information layers. With this method, the resin layers are formed by an inkjet coating method in which a curable resin is discharged at the substrate while either the substrate or an inkjet head is moved relative to the other. The inkjet coating is performed in a coating pattern in which the amount of resin dropped onto the substrate per unit of surface area varies for each of the regions that are aligned in the radial direction of the substrate.

Of the coating regions, the amount of resin dropped per unit of surface area in the innermost peripheral region and/or the outermost peripheral region is less than the amount of resin dropped per unit of surface area in an adjacent coating region that is adjacent to the innermost peripheral region and/or the outermost peripheral region.

The ratio of the amount of resin dropped per unit of surface area in the innermost peripheral region and/or the outermost peripheral region to the amount of resin dropped per unit of surface area in the adjacent coating region may satisfy the following conditions. Specifically, of the plurality of resin layers, this ratio in the resin layer applied adjacent to the substrate is same as or greater than the ratio in the resin layers applied over said resin layer.

The above-mentioned ratio is preferably changed according to the thickness of the resin layers.

The amount of resin dropped per unit of surface area can be varied by using either of the following two methods. Preferably, this is a method in which the amount of resin droplets discharged from the inkjet head is varied, or a method in which the coating resolution in the relative movement direction of the substrate with respect to the inkjet head, or a direction perpendicular to the relative movement direction, is varied.

The inkjet head preferably has a structure with which the curable resin is discharged according to a signal pattern applied to the inkjet head. The signal pattern may be a multipulse pattern corresponding to a single droplet, and a pattern in which this multipulse pattern is repeated at a specific discharge period.

The droplet amount may be changed by changing the pulse number of the multipulse pattern.

The droplet amount may be changed by changing the pulse amplitude of the multipulse pattern.

The coating resolution may be changed by changing the discharge period.

The inkjet head may have a piezoelectric element, and the curable resin may be discharged according to the signal pattern applied to the piezoelectric element.

The inkjet head may have a heater, and the curable resin may be discharged according to the signal pattern applied to the heater.

The discharge width of the curable resin with the inkjet head may be at least the width of the substrate in a perpendicular relation to the travel direction of the inkjet head.

The curable resin may be a radiation curable resin.

The radiation curable resin may be a UV curable resin.

### ADVANTAGEOUS EFFECTS

With the present invention, resin layers of different thickness can be formed by using an inkjet coating method in which a curable resin is discharged at the substrate while either the substrate or an inkjet head is moved relative to the other. Furthermore, the inkjet coating is performed in a coating pattern in which the amount of resin dropped onto the substrate per unit of surface area varies for each of the regions that are aligned in the radial direction of the substrate, which has the following effect. The influence of build-up at the ends of the coating region that occurs in the production of a multilayer information recording medium composed of a plurality of information layers is eliminated, and a resin intermediate layer having a uniform film thickness can be achieved.

### BRIEF DESCRIPTION OF DRAWINGS

FIG. 1 illustrates an example of the resin coating region obtained with an inkjet coating apparatus in Embodiment 1 of the present invention;

FIG. 2 is a cross section illustrating an example of the structure of a multilayer information recording medium in Embodiment 1 of the present invention;

FIG. 3 illustrates an example of the step of transferring an information face to a resin intermediate layer in Embodiment 1 of the present invention;

FIG. 4 illustrates an inkjet coating apparatus in Embodiment 1 of the present invention;

FIG. 5 is a cross section of a typical structural example of an inkjet nozzle;

FIG. 6 illustrates an example of the nozzle layout with an inkjet head;

FIG. 7 illustrates the structure of the inkjet head in Embodiment 1 of the present invention;

FIG. 8 illustrates the relationship between the substrate and the inkjet nozzle in Embodiment 1 of the present invention;

FIG. 9 illustrates a multipulse pattern inputted to the inkjet head in Embodiment 1 of the present invention;

FIG. 10 illustrates an example of the shape of the build-up at the end face of the resin intermediate layer that is formed;

FIG. 11 is a cross section illustrating an example of the structure of a multilayer information recording medium in Embodiment 2 of the present invention;

FIG. 12 is a cross section of a conventional two-layer Blu-ray Disc;

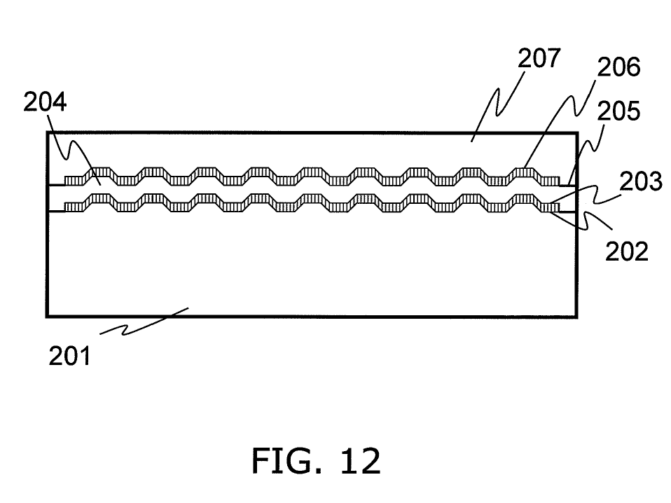

FIG. 13 illustrates a conventional stamper production process; and

FIG. 14 illustrates a conventional process for producing a two-layer disk consisting of steps for producing a protective layer and a resin intermediate layer using spin coating.

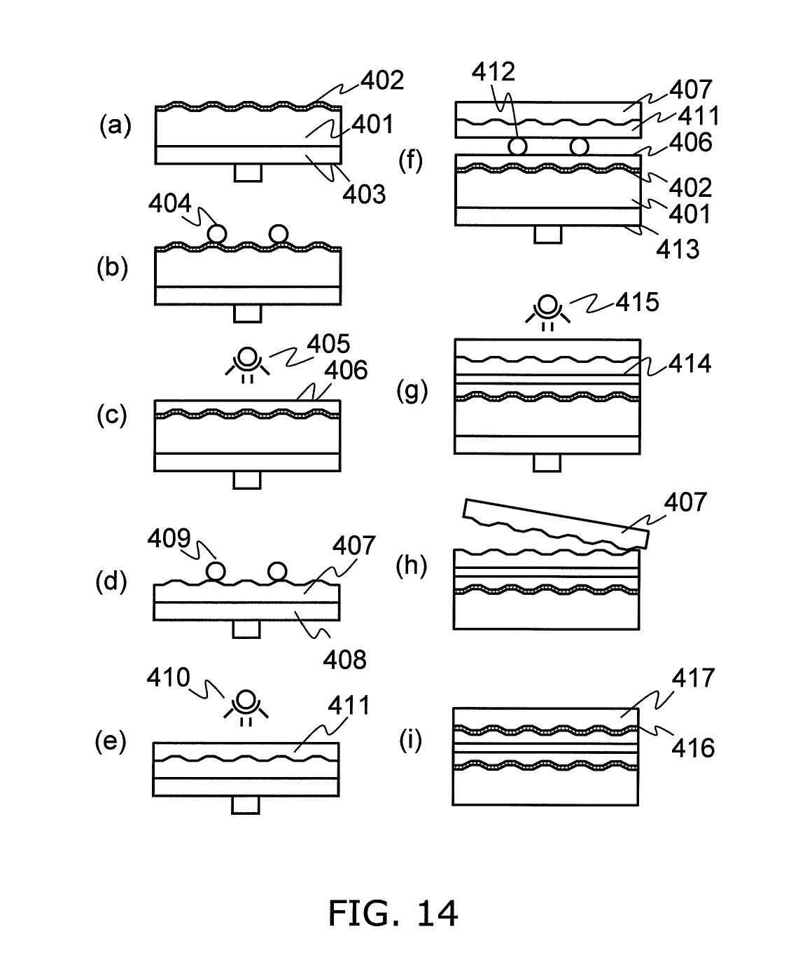

### KEY

101 substrate
102 innermost peripheral coating region
103 intermediate coating region
104 outermost peripheral coating region
201 molded resin substrate
202 first information face
203 first information layer
204 resin intermediate layer
205 second information face
206 second information layer
207 protective layer
301 base
302 photosensitive film
303 exposure beam
304 exposed part
305 bump pattern
306 recording base
307 conductive thin film
308 metal sheet
309 metal stamper
401 molded resin substrate
402 first information layer
403 rotary stage
404 radiation curable resin A
405 radiation emitter
406 resin layer
407 transfer stamper
408 rotary stage
409 radiation curable resin B
410 radiation emitter
411 resin layer
412 radiation curable resin C
413 rotary stage
414 resin layer
415 radiation emitter
416 second information layer
417 protective layer
501 discharge liquid
502 piezoelectric element or other vibrational element
503 heater
504 discharge liquid
601 molded resin substrate
602 first information face
603 first information layer
604 first resin intermediate layer
605 second information face
606 second information layer
607 second resin intermediate layer
608 third information face
609 third information layer
610 protective layer
701 molded resin substrate
702 first information layer
703 radiation curable resin
704 transfer stamper
705 center boss
706 pressure plate
707 vacuum chamber
708 vacuum pump
709 radiation emitting apparatus
710 first resin intermediate layer
801 molded resin substrate
802 first information layer
803 stage
804 inkjet head unit
805 inkjet head
806 micro-droplets of radiation curable resin A
807 radiation curable resin
901 inkjet nozzle
902 inkjet head
1001 molded resin substrate
1002 specific place
1003 inkjet head unit
1004 inkjet head unit
1101 inkjet nozzle
1102 inkjet head
1103 molded resin substrate
1301 substrate
1302 first information layer
1303 resin layer
1401 molded resin substrate
1402 first information face
1403 first information layer
1404 first resin intermediate layer
1405 second information face
1406 second information layer
1407 second resin intermediate layer
1408 third information face
1409 third information layer
1410 third resin intermediate layer
1411 fourth information face
1412 fourth information layer
1413 protective layer

### BEST MODE FOR CARRYING OUT THE INVENTION

### Summary of the Invention

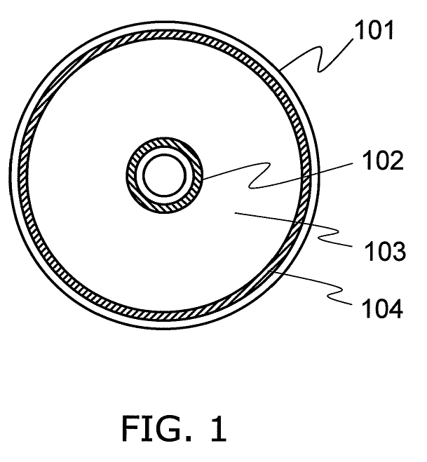

The method for manufacturing an information recording medium pertaining to the present invention is a method for manufacturing an information recording medium produced by the lamination of a substrate, a plurality of information layers, and a plurality of resin layers of different thickness that separate the information layers. With this method, the resin layers are formed by an inkjet coating method in which a curable resin is discharged at the substrate while either the substrate or an inkjet head is moved relative to the other. The inkjet coating is performed in a coating pattern in which the amount of resin dropped onto the substrate per unit of surface area varies for each of the regions that are aligned in the radial direction of the substrate. The phrase “for each of the regions that are aligned in the radial direction of the substrate” is illustrated in FIG. 1, for example, in which the plurality of coating regions consists of three regions: an innermost peripheral coating region 102, an intermediate coating region 103, and an outermost peripheral coating region 104.

Furthermore, the amount of resin dropped per unit of surface area in the innermost peripheral coating region 102 and/or the outermost peripheral coating region 104 is less than the amount of resin dropped per unit of surface area in the intermediate coating region 103.

With the present invention, resin layers of different thickness can be formed by using an inkjet coating method in which a curable resin is discharged at the substrate while either the substrate or an inkjet head is moved relative to the other. Furthermore, the inkjet coating is performed in a coating pattern in which the amount of resin dropped onto the substrate per unit of surface area varies for each of the regions that are aligned in the radial direction of the substrate, which has the following effect. The influence of build-up of the innermost peripheral coating region 102 and/or the outermost peripheral coating region 104 that occurs in the production of a multilayer information recording medium composed of a plurality of information layers is eliminated, and a resin intermediate layer having a uniform film thickness can be achieved.

Formation of Resin Layer by Inkjet Printing

The formation of a resin layer by inkjet printing as it relates to the method for manufacturing an information recording medium pertaining to the present invention will now be described. Inkjet methods for discharging a resin are divided into two main types: piezo and thermal. There are also many other methods for discharging a resin, but what they all have in common is a structure in which micro-droplets are discharged from a small-diameter inkjet nozzle, so only a discharge liquid with low viscosity can be discharged. This does not refer to the viscosity of the discharge liquid in the liquid tank at normal temperature, and is restricted to the resin viscosity near the discharge openings of the inkjet nozzle. Accordingly, there are times when a method is used in which the discharge liquid viscosity is first lowered by heating (with a heater or the like) the area around the discharge openings in the inkjet nozzle, for example. With the inkjet nozzles that are commonly used or commercially available at present, the viscosity near the discharge openings of a discharge liquid that can be discharged ranges from about a few mPa·s to a few dozen mPa·s. Accordingly, in the production of a resin intermediate layer by inkjet method, a low viscosity resin is discharged, which means that the resin may run, etc., after coating. Also, since only micro-droplets with a volume of about 1 pL to 1 mL can be discharged as mentioned above, it is extremely difficult to apply a resin layer whose thickness is over 10 μm, for instance. Consequently, this method was never used in the manufacture of multilayer information recording media composed of a plurality of resin layers of different thickness.

However, the discharge of micro-droplets from an inkjet nozzle is extremely fast, and coating takes less than half the time as with a conventional spin coating method. Also, as mentioned previously, no special mask or the like is necessary, and many different patterns can be applied to the desired coating region.

In light of the above, the inventors of the present invention decided to form the resin layers of different thickness that occur in the production of a multilayer information recording medium by using inkjet printing. Furthermore, the inventors of the present invention realized the present invention with the goal of eliminating the influence of the build-up at the end of the coating region that is caused by lamination coating by using inkjet printing.

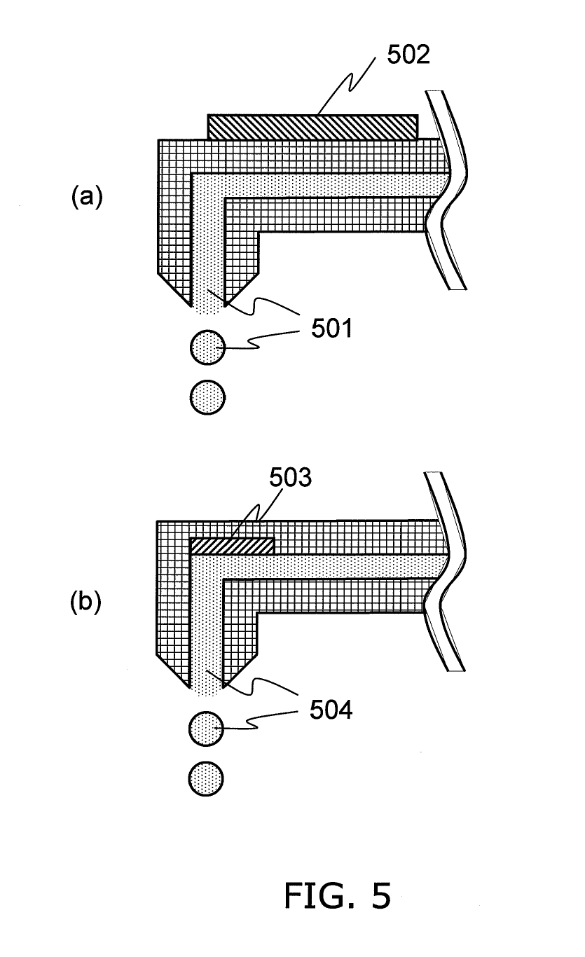

FIG. 5 consists of cross sections of a typical example of the structure of an inkjet nozzle. The liquid tank, the supply path of the discharged liquid, and so forth are not shown in this drawing. FIG. 5a shows a type with which the discharge liquid 501 is discharged by being pushed out by a piezoelectric element or another such vibrational element 502, and is called a piezo inkjet nozzle. FIG. 5b shows a type with which the discharge liquid is instantly boiled with a heater 503, so that the volumetric expansion of the discharge liquid 504 near the heater serves as the motive force in discharge, and this is called a thermal type.

### Embodiment 1

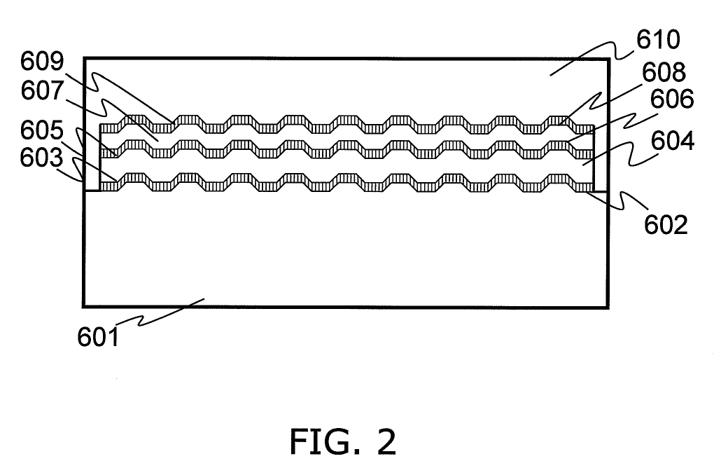

In Embodiment 1, a method for manufacturing the three-layer information recording medium (in which there are three information layers) shown in FIG. 2 will be described as an example.

This three-layer information recording medium has a molded resin substrate 601, a first information layer 603, a first resin intermediate layer 604, a second information layer 606, a second resin intermediate layer 607, a third information layer 609, and a protective layer 610. The first information layer 603, the second information layer 606, the second resin intermediate layer 607, and the third information layer 609 are composed of a metal thin film, or a thin film material that allows thermal recording. The first resin intermediate layer 604, the second resin intermediate layer 607, and the protective layer 610 are composed of a resin that is substantially transparent with respect to the recording and reproduction light.

A first information face 602 is formed by bumps on the molded resin substrate 601. The first information layer 603 is laminated over the molded resin substrate 601. The first resin intermediate layer 604 is formed over the first information layer 603. A second information face 605 consisting of bumps is formed over the first resin intermediate layer 604. The second information layer 606 is laminated over the second information face 605. The second resin intermediate layer 607 is formed over the second information layer 606. A third information face 608 consisting of bumps is formed over the second resin intermediate layer 607. The third information layer 609 is laminated over the third information face 608. The protective layer 610 covers the third information layer 609.

The “substantially transparent” referred to here means having a transmissivity of about 90% or higher with respect to the recording and reproduction light, and “semitransparent” means having a transmissivity of at least 10% but no higher than 90% with respect to the recording and reproduction light.

With this three-layer Blu-ray Disc, a laser beam is incident from the protective layer 610 side, and signals can be recorded, reproduced, etc., by focusing the beam on the information layer where recording and reproduction are to be performed (from out of the first, second, and third information layers).

The thickness of the molded resin substrate 601 is approximately 1.1 mm, the thickness of the first resin intermediate layer 604 and the second resin intermediate layer 607 is set to approximately 25 μm and approximately 17 μm respectively, and the thickness of the protective layer 610 is set to approximately 58 μm. The resin intermediate layers and protective layer are not limited to these thicknesses, however, which can be set as desired.

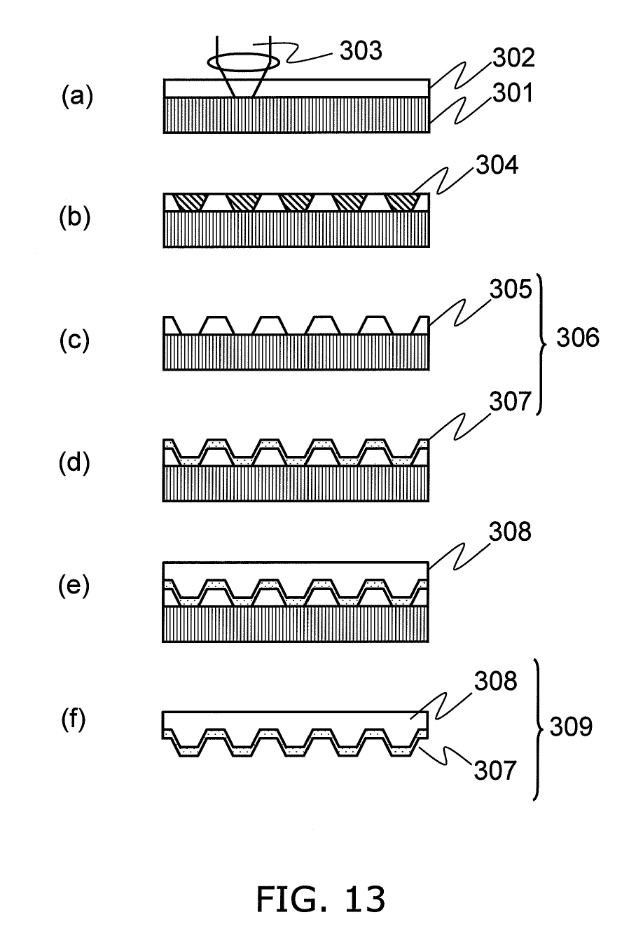

The molded resin substrate 601 is formed from a disk composed of a polycarbonate or acrylic resin with an outside diameter of 120 mm, a center hole diameter of 15 mm, and a thickness of about 1.0 to 1.1 mm, so as to be interchangeable in terms of shape with CDs, DVDs, and other such optical disks. An information face such as guide grooves formed by bumps on one side is formed on the molded resin substrate 601 by resin molding (such as injection molding) using a metal stamper as shown in FIG. 13f. In Embodiment 1, a polycarbonate was used in the production.

If the information recording medium is a read-only medium, then the first information layer 603 may have at least the characteristic of reflecting reproduction light, and is formed, for example, by sputtering, vapor deposition, or another such method from a reflective material such as Al, Ag, Au, Si, SiO₂, or TiO₂. If the information recording medium is a recordable medium, then it will be necessary to write information by irradiation with recording light, so the medium may include at least a layer composed of a recording material such as phthalocyanine or another such organic dye, or a phase change material such as GeSbTe. If needed, a layer that will enhance the recording and reproduction characteristics may also be included, such as a reflecting layer or an interface layer. The second information layer 606 and the third information layer 609 can be formed in the same way. Since recording and reproduction are carried out by shining recording and reproduction light at the various information layers from the protective layer 610 side, the second information layer 606 and the third information layer 609 are constituted so that their transmissivity with respect to the wavelength of the recording and reproduction light is higher than that of the first information layer 603.

The first resin intermediate layer 604 and the second resin intermediate layer 607 are substantially transparent with respect to the recording and reproduction light, and can be made, for example, from a UV curing resin whose main component is acrylic, a UV curing resin based on epoxy, or another such radiation curable resin. The “substantially transparent” referred to here means having a transmissivity of about 90% or higher with respect to the recording and reproduction light, and a material having a transmissivity of at least 95% is even better. The method for producing the first resin intermediate layer 604 consists of the following two steps. In the first step, the first information layer 603 is coated with a liquid radiation curable resin by the inkjet coating method described below. In the second step, a transfer stamper having an information face such as pits or guide grooves is utilized to transfer the information face to the radiation curable resin. The method for producing the second resin intermediate layer 607 is the same.

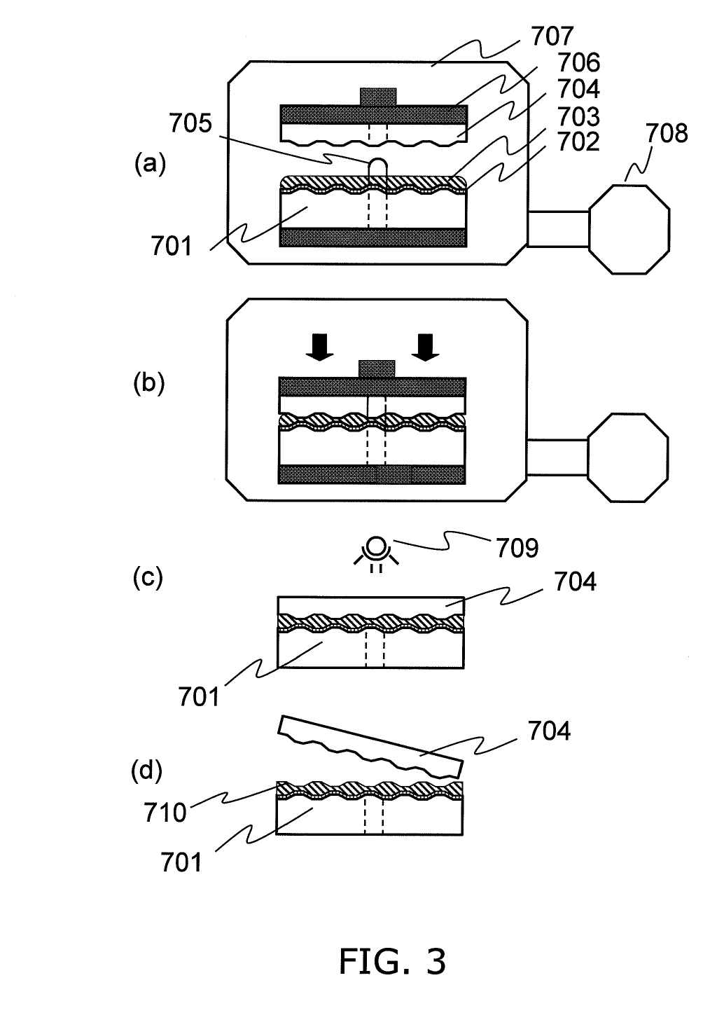

FIG. 3 illustrates an example of the step of transferring an information face to a resin intermediate layer in Embodiment 1 of the present invention. A molded resin substrate 701 is transported into a vacuum chamber 707. The molded resin substrate 701 has a first information layer 702 that has been coated with a radiation curable resin 703. A transfer stamper 704 is also disposed inside the vacuum chamber 707 here (FIG. 3a).

The transfer stamper 704 is made from a polyolefin material, which is a material that parts well from a radiation curable resin, and is formed thinner than the molded resin substrate, in a thickness of 0.6 mm, for example. The purpose of this is so that when the transfer stamper is separated from the molded resin substrate, which is approximately 1.1 mm thick, the stiffness difference that results from the different thickness of the substrate can be utilized to bend back and separate the transfer stamper. A polyolefin material makes it easy to produce an information face such as pits or guide grooves formed by bumps on one side by a method such as injection molding using a conventional metal stamper, just as with the molded resin substrate. Also, since polyolefin materials have high transmissivity with respect to radiation such as UV rays, the radiation curable resin can be efficiently cured by irradiation through the transfer stamper. Furthermore, since polyolefin materials have low adhesion to a radiation curable resin that has been cured, they can be easily parted from the interface with the radiation curable resin after curing.

A center hole is made in the center of the transfer stamper 704 for eliminating eccentricity with the molded resin substrate 701 via a center boss 705. The inside of the vacuum chamber 707 is evacuated by a rotary pump, a turbo molecular pump, or another such vacuum chamber 708, with a vacuum atmosphere being produced in a short time. In Embodiment 1 of the present invention, when the pressure inside the vacuum chamber 707 reaches a degree of vacuum of 100 Pa or less, the transfer stamper 704 is placed over the molded resin substrate 701 (FIG. 3b). A pressure plate 706 that is installed above the transfer stamper 704 applies pressure to the transfer stamper 704 at this point, and the information face on the transfer stamper 704 is transferred to the radiation curable resin 703.

Because the inside of the vacuum chamber 707 is a vacuum atmosphere, the radiation curable resin 703 and the transfer stamper 704 can be stuck together without any bubbles being trapped in between. The molded resin substrate 701 and transfer stamper 704 that have been stuck together are irradiated with radiation through the transfer stamper 704 by a radiation emitting apparatus 709, either inside the vacuum chamber 707 or after being taken out (FIG. 3c). After this, a wedge is driven between the transfer stamper 704 and the molded resin substrate 701, or compressed air is blown in, etc., to separate the transfer stamper 704 from the interface with the radiation curable resin 703 (FIG. 3d). This forms a first resin intermediate layer 710 to which an information face has been transferred.

Besides what is discussed here, various other methods can also be used for transferring an information face to a radiation curable resin, such as using a metal or other different material as the transfer stamper, or irradiating with radiation from the molded resin substrate side. Whatever the method, it does not limit the effect of the invention in Embodiment 1.

The protective layer 610 is substantially transparent with respect to the recording and reproduction light, and can be, for example, a UV curable resin whose main component is acrylic, or a radiation curable resin such as an epoxy-based UV curable resin. The “substantially transparent” referred to here means having a transmissivity of about 90% or higher with respect to the recording and reproduction light, and a material having a transmissivity of at least 95% is even better. The protective layer 610 can be formed by any of various methods, such as spin coating, screen printing, gravure printing, or inkjet printing. Ideally, the same method as that used in the resin intermediate layer formation step is used as the method for forming the protective layer. For example, when the resin intermediate layer is applied by inkjet method, it is best if the protective layer is also produced by inkjet method. Also, coating with a radiation curable resin is not the only method for forming the protective layer, and it may instead be formed, for example, by affixing a sheet of material such as a polycarbonate resin or an acrylic resin, with an adhesive or the like in between.

With the multilayer information recording medium in Embodiment 1 of the present invention, recording and reproduction are performed by using a blue-violet laser with a laser beam of 405 nm, and using an objective lens with a NA of 0.85 to focus the beam on each information layer from the protective layer 610 side. The thickness from the surface of the protective layer 610 to the first information layer 603 is set to approximately 0.1 mm to reduce the effect of disk tilt.

The thickness setting values of this resin intermediate layer, however, are just an example, and the effect of the present invention will be the same at other thickness setting values.

A brief summary was given above of the constitution of and method for manufacturing a multilayer information recording medium in Embodiment 1 of the present invention, but the method for manufacturing a multilayer information recording medium of the present invention is characterized by the method for forming the information recording layer, and therefore the scope of the present invention is not limited by the constitution or manufacturing method of the rest.

The method for manufacturing a multilayer information recording medium in Embodiment 1 of the present invention, and particularly the method for producing the resin intermediate layer, will now be described in detail.

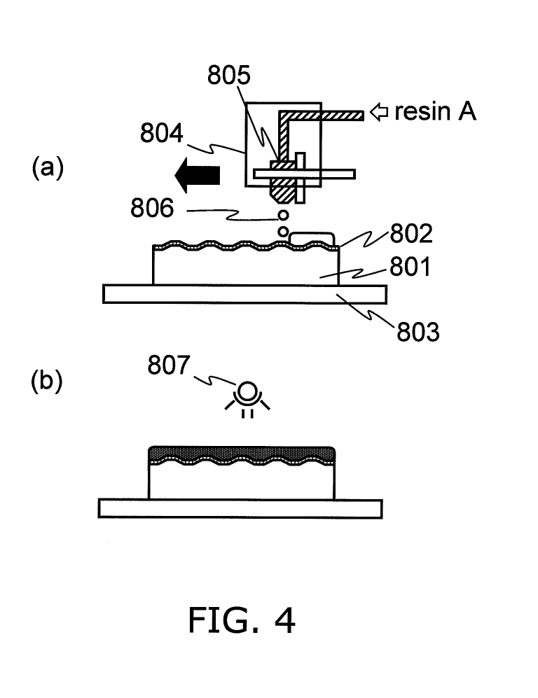

FIG. 4 illustrates an example of the step of applying a radiation curable resin using an inkjet coating apparatus in Embodiment 1 of the present invention.

First, as shown in FIG. 4a, a molded resin substrate 801 having a first information layer 802 formed on one side is fixed to a stage 803 by vacuum chucking or the like. An inkjet head unit 804 is disposed above the molded resin substrate 801. The stage 803 and the inkjet head unit 804 are able to move relative to one another.

The method for fixing the inkjet head unit 804 and coating by parallel movement of the stage 803 will now be described. However, the stage 803 and the inkjet head unit 804 need only be moved relatively, so the stage 803 may instead be fixed and the inkjet head unit 804 moved in parallel, or both may be used.

The inkjet head unit 804 is moved in parallel with respect to the stage 803 while micro-droplets 806 of the radiation curable resin A are dropped from an inkjet head 805 onto the molded resin substrate 801. Also, a heater can be provided to the inkjet head 805 to heat and reduce the viscosity of the resin in the inkjet head 805.

After the coating region of the molded resin substrate 801 has been coated with the micro-droplets 806 of the radiation curable resin A, the stage 803 is moved under a radiation curable resin 807, the stage 803 is moved, the surface is irradiated with radiation, and the coating of radiation curable resin is cured (FIG. 4b). A UV lamp was used as the irradiation means here. There are various kinds of UV lamp, such as metal halide lamps, high-pressure mercury vapor lamps, and xenon lamps, but a xenon lamp was used here. However, the type of lamp is not limited to this, and the wavelength of the radiation, etc., must be selected according to the radiation curable resin being applied.

The region irradiated with radiation may be completely cured, but even if it is not completely cured, as long as it is cured to a state corresponding to this, the flow of resin can be suppressed. The phrase “a state corresponding to complete curing” used here refers to a state in which the resin is in the form of a gel or has a viscosity of at least 10,000 mPa·s.

When a resin intermediate layer is being produced, the step of transferring the information face to the resin intermediate layer as discussed above comes after this coating step, so the last radiation curable resin layer that is applied is sent to the information face transfer step shown in FIG. 3 without being cured, or after being cured completely so that the information face can be transferred.

If this coating step is the protective layer production step, then no information layer transfer step is necessary, so the last radiation curable resin layer that is applied will also be completely cured.

The constitution of the inkjet head 805 will now be described.

One or more inkjet nozzles are provided to the inkjet head 805. These nozzles are the ones generally used in printers used for printing text or drawing. An inkjet nozzle can discharge micro-droplets of ink whose main component is a pigment, dye, etc. With inkjet technology, development has been conducted to make the droplets as small as possible, such as droplets with a volume of about a few picoliters, and to drop these at high precision to achieve printing of higher resolution. Nevertheless, since there is no need with the present invention to form a relatively thick resin layer of 10 μm or more, for example, it is preferable to use an inkjet nozzle that can discharge droplets that are as large as possible. For instance, it is preferable to use an inkjet nozzle capable of discharging large droplets of about a few dozen picoliters. With printer-use inkjet nozzles that are currently readily available, the volume of the micro-droplets is about 5 to 50 pL, the corresponding dischargeable resin viscosity is about 5 to 20 mPa·s around the discharge area, and the operating frequency is about 1 to 20 kHz.

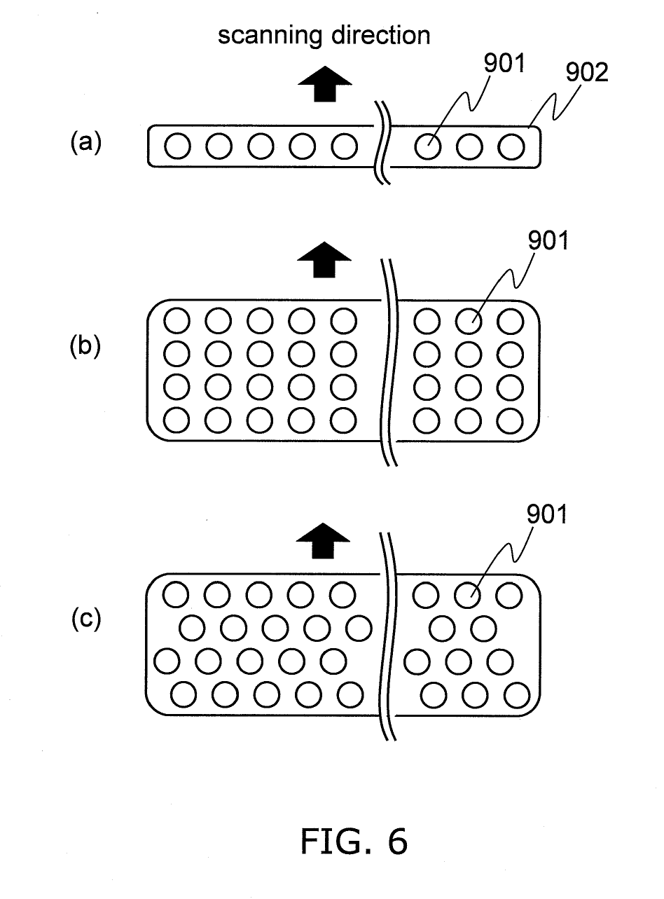

An inkjet head that has only one inkjet nozzle is possible, but providing a plurality of inkjet nozzles is a relatively simple matter. For example, as shown in FIG. 6a, there is a configuration in which inkjet nozzles 901 are arranged in a row perpendicular to the scanning direction of an inkjet head 902, and as shown in FIG. 6b, there is a configuration in which a plurality of these 5 rows are arranged in the scanning direction. Alternatively, as shown in FIG. 6c, there is a configuration in which a plurality of rows are arranged, with the positions of the inkjet nozzles 901 offset slightly from row to row. The configuration of the nozzles in this inkjet head can be expressed by an index called nozzle resolution. Nozzle resolution refers to the number of nozzles provided per unit of length. For example, the number of nozzles per inch can be expressed in units of npi (nozzles per inch).

In Embodiment 1 of the present invention, an inkjet head with a nozzle resolution of 600 npi was used as the inkjet head 805. A piezo system was used to discharge the resin, in which a piezoelectric element is used to push out the resin according to a signal pattern inputted to the piezoelectric element. However, the configuration of the inkjet head need not be the piezo type used in Embodiment 1, and the effect of the invention in Embodiment will be the same with a thermal head.

In Embodiment 1 of the present invention, it is preferable if the coating can be done in a length of 120 mm, which is the diameter of the molded resin substrate 801 that is the object of coating, in a single pass. In view of this, it is possible to arrange one or more rows of nozzles perpendicular to the scanning direction of the inkjet head, in a straight line and in a width of at least 120 mm.

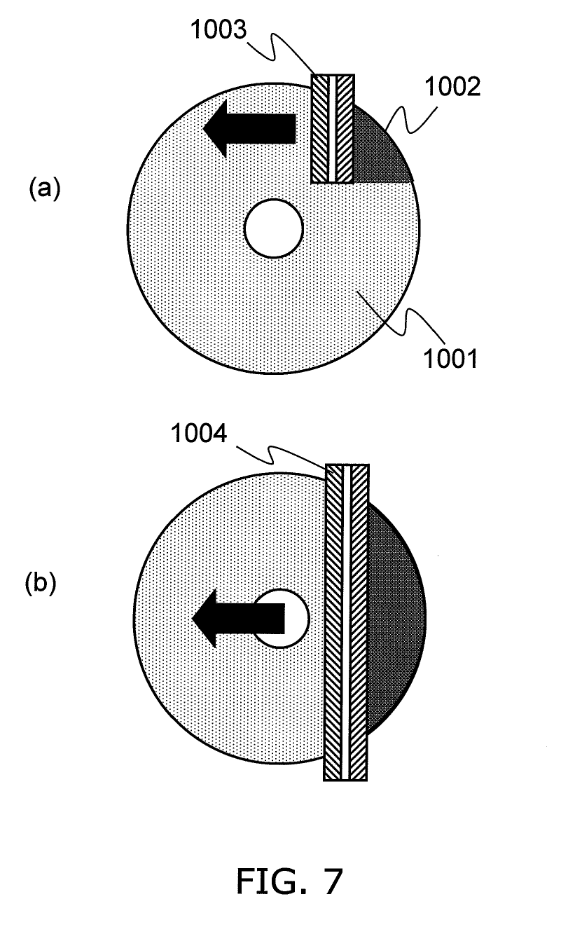

As shown in FIG. 7a, it is also possible to apply the coating with an inkjet head unit 1003, whose discharge width is narrower than the length of the coating object in a direction perpendicular to the scanning direction of the inkjet head (here, 120 mm, which is the diameter of the molded resin substrate 1001 serving as the coating object). In FIG. 7a, coating is commenced from a specific location 1002 of the molded resin substrate 1001. However, the coating region cannot be coated in a single scan of the inkjet head. Also, the following problems are encountered if coating is performed by scanning the inkjet head a number of times over the substrate while shifting the scan by the width of the inkjet head each time. The seams between coated coating regions may have uneven thickness distribution, and resin applied subsequently may splatter onto the previously coated coating regions.

Accordingly, as shown in FIG. 7b, a preferable configuration is one in which an inkjet head unit 1004 is longer than the diameter of the molded resin substrate 1001.

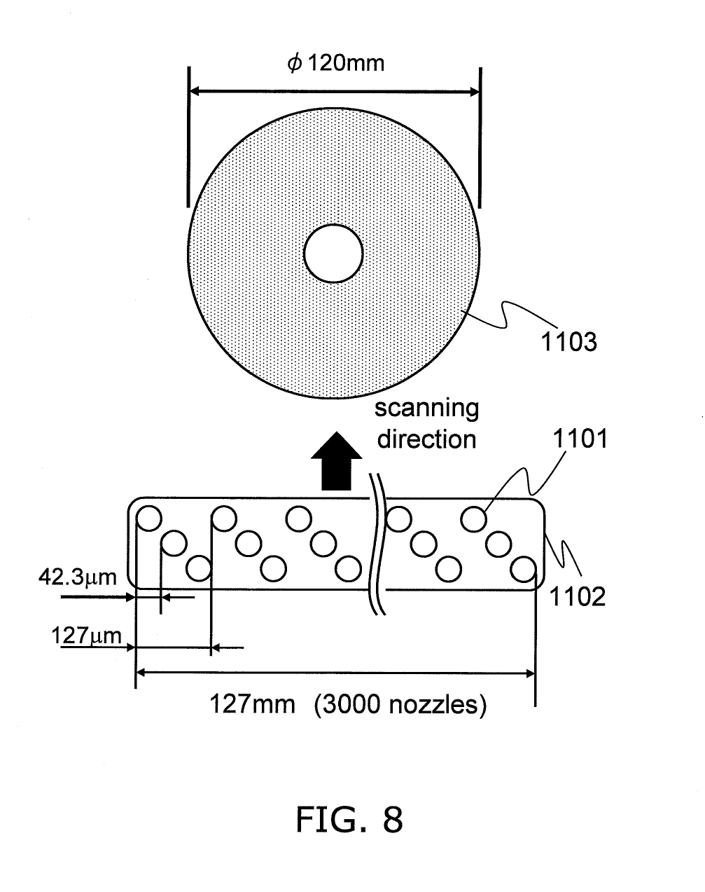

In view of this, with the inkjet coating apparatus in Embodiment 1 of the present invention, the molded resin substrate 1103 is coated using inkjet nozzles with a drive frequency of 7 hKz. More specifically, as shown in FIG. 8, 1000 inkjet nozzles 1101 are arranged in a straight line, perpendicular to the scanning direction and at a pitch of 141 μm, and three of these rows are used, with each row offset by 42.3 μm. Furthermore, an inkjet head 1102 provided with 3000 nozzles and an inkjet head length of 127 mm is used. This inkjet head configuration corresponds to a nozzle resolution of 600 npi. The discharge of resin can be selectively controlled for each of the inkjet nozzles. When all of the nozzles are used for discharge the resin, the resin can be dropped at a resolution of 600 dpi (dots per inch). For example, when resin is dropped using 1000 nozzles arranged in a single row, the resin is dropped at a resolution of 200 dpi. Thus selecting as desired the number of inkjet nozzles that drop the resin makes it possible to set as desired the resolution at which the resin is dropped. This is a method for changing the coating resolution in a direction perpendicular to the relative movement direction of the substrate with respect to the inkjet head, and is one way to change the coating resolution.

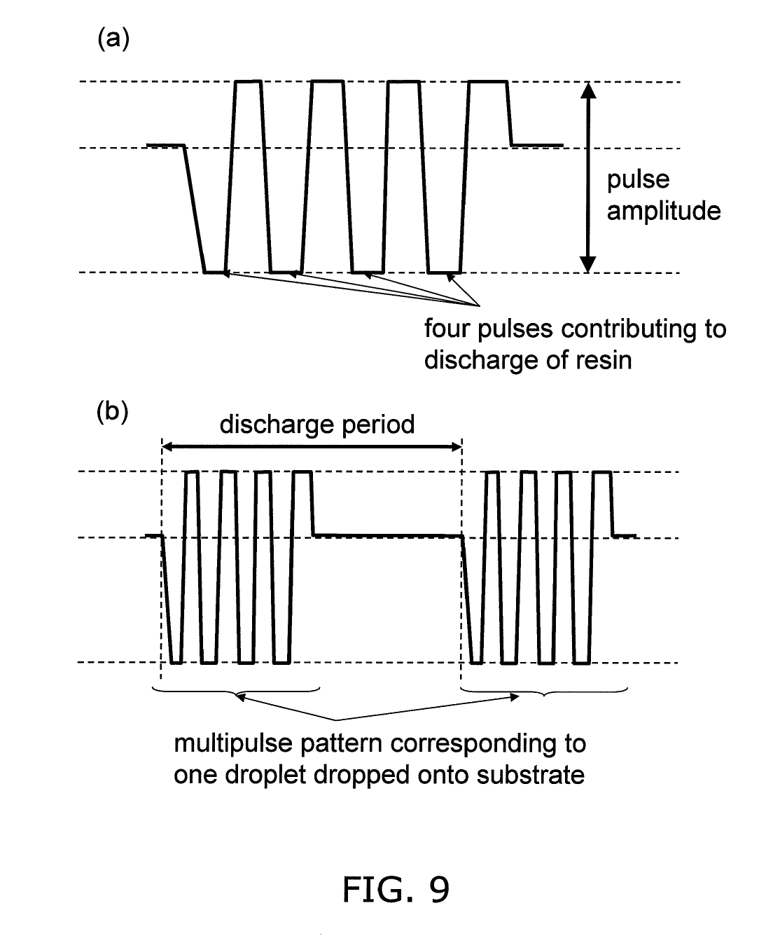

When resin is dropped from the inkjet head, a signal pattern consisting of the multipulse pattern shown in FIG. 9a is inputted to the inkjet head, whereupon the resin is pushed out from the inkjet nozzles and dropped onto the substrate. This is because the resin is efficiently discharged from the inkjet nozzles filled with resin by utilizing the mechanical resonance produced when the force of pushing out the resin from the nozzles is applied to the head by a heater, a piezoelectric element, or the like provided to the head. For example, the multipulse pattern consisting of four pulses shown in FIG. 9a is set to a pulse period with a frequency close to the mechanical resonance around the inkjet nozzles filled with resin. Four resin droplets discharged according one pulse are discharged from the nozzle openings, after which they merge in the air before reaching the substrate, and are dropped onto the substrate in the form of a single droplet. Therefore, if the amplitude of this multipulse pattern is changed, the amount of resin pushed out from the nozzles by the pulse varies, and changing the pulse number from four to five results in the amount of resin droplet increasing to 1.25 times. By thus changing the amplitude of the multipulse pattern, or setting the number of pulses that make up the multipulse pattern as desired, the amount of resin in one drop discharged from the inkjet nozzles can be changed. This functions as a droplet amount change method for changing the amount of resin dropped onto the substrate.

Also, the use of this multipulse pattern makes it possible for the inkjet nozzle to discharge resin stably in an amount of about 15 pL per drop, as long as the resin viscosity is about 5 to 20 mPa·s.

In dropping the resin onto the substrate, the resin is preferably dropped continuously onto the substrate while the substrate or the inkjet head is moved relatively. However, the coating resolution in the relative movement direction of the substrate with respect to the inkjet head is determined by the relative movement speed of the substrate with respect to the inkjet head and the timing at which the resin discharged from the inkjet head is dropped. The timing at which the resin discharged from the inkjet head is dropped is adjusted by repeating the multipulse pattern discussed above at a specific discharge period, as shown in FIG. 9b. The discharge period can be set as desired to vary the coating resolution in the relative movement direction of the substrate with respect to the inkjet head. Of course, if the multipulse pattern is eliminated at this discharge period timing, the resin will not be dropped, so it is possible to drop the resin at the desired coating locations. This is one way to vary the coating resolution in the relative movement direction of the substrate with respect to the inkjet head.

### Working Example 1

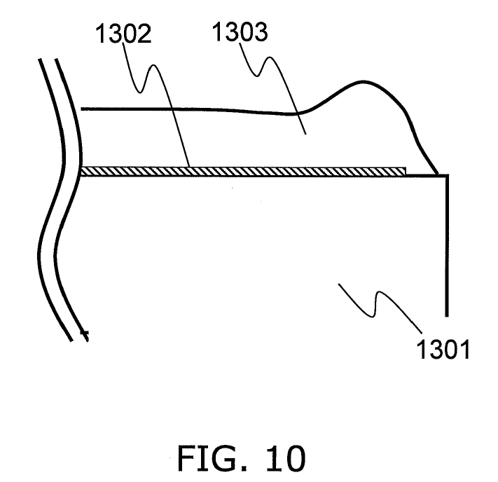

Working Example 1 will now be described. As shown in FIG. 1, Working Example 1 is an experiment, and the results thereof, in which the coating region was divided into a plurality of regions, the resin drop amount per unit of surface area was varied for each coating region, and the conditions that eliminated build-up at the coating end faces shown in FIG. 10 were examined. The “plurality of coating regions” comprised three regions: the innermost peripheral coating region 102, the intermediate coating region 103, and the outermost peripheral coating region 104.

The three-layer information recording medium shown in FIG. 2 was produced using the above-mentioned inkjet coating apparatus. With inkjet coating, unlike spin coating or other such methods, there is no need for a special mask or the like for limiting the coating region, and resin can be dropped in the desired amount per unit of surface area in the desired region.

In Working Example 1, when the first resin intermediate layer 604 in FIG. 2 was applied, it was applied by changing the amount of resin dropped in regions partitioned into concentric circles, using the center of the substrate 101 as a reference as shown in FIG. 1. Here, the coating region was divided into three regions (the innermost peripheral coating region 102, the intermediate coating region 103, and the outermost peripheral coating region 104) partitioned into concentric circles, using the center of the substrate 101 as a reference, and coating was performed in different drop amounts per unit of surface area for the various regions. The resin used here was a UV curable acrylic resin, and its viscosity at a temperature of 25° C. was approximately 10 mPa·s.

First, the first resin intermediate layer 604 shown in FIG. 2 was formed in a thickness of 25 μm.

In general, the following problem is encountered when regions partitioned into concentric circles are coated without varying the amount of resin dropped per unit of surface area. The first resin intermediate layer is formed over the first information layer formed on the substrate. The first information layer is not formed over the entire surface of the substrate, from its innermost diameter to its outermost diameter, and the substrate surface is exposed near its inside and outside diameters, and the first resin intermediate layer is formed so as to cover and hide the first information layer. Therefore, the radiation curable resin touches the substrate surface at the innermost and outermost peripheral parts of the resin coated region. Accordingly, the resin coated end faces rise up at a contact angle determined by the surface properties of the substrate, the surface tension of the resin, and other such factors, and it can be seen in FIG. 10 how resin builds up at the end faces. In FIG. 10, a first information layer 1302 is formed over a substrate 1301. A resin layer 1303 completely covers the first information layer 1302, and also covers the exposed outer peripheral end of the substrate 1301. The outer peripheral end of the resin layer 1303 rises up more than the flat portion further inward, and then drops off toward the outer peripheral side.

Out of the coating region, the innermost peripheral coating region 102 was the region from a diameter of 22 mm to a diameter of 24 mm, the intermediate coating region 103 was the region from a diameter of 24 mm to a diameter of 117 mm, and the outermost peripheral coating region 104 was the region from a diameter of 117 mm to a diameter of 119 mm.

The thickness of the first resin intermediate layer 604 was measured as follows. Using a laser with a wavelength of 405 nm as the light source, the beam was focused with a lens, and the lens was moved by an actuator while the beam was focused on the information layer formed on the molded resin substrate surface or the resin intermediate layer surface. A thickness gauge was used to measure the thickness from the amount this actuator was driven.

Table 1 shows the results of measuring build-up at the coated end face and the amount of resin dropped per unit of surface area for each region. Condition numbers 4 and 5 are working examples pertaining to the present invention, while condition numbers 1 to 3 and 6 to 8 are comparative examples.

Here, the inkjet head was fixed and coating was performed while the substrate was moved underneath at a constant speed of 120 mm/s. The coating resolution perpendicular to the relative movement direction of the substrate and the inkjet head was 600 dpi, and the amount of resin dropped per unit of surface area was varied by varying the coating resolution in the relative movement direction of the substrate and the inkjet head. Changes in the coating resolution were achieved by varying the discharge period of the multipulse pattern. After the substrate had passed under the inkjet head, the resin was irradiated with UV rays approximately one second later using a radiation emitting apparatus (a xenon UV lamp was used here), to effect semi-curing. Build-up at the end face was evaluated as follows. The thickness differences between the average thickness near a radius of 40 mm of an information recording medium with a diameter of 120 mm and the maximum or minimum value for thickness at a radius of 12 mm (the innermost peripheral end face), and between the average thickness and the maximum or minimum value for thickness at a radius of 58 mm (the outermost peripheral end face) were found. The acceptability standard was that the thickness differences were in the range of ±1 μml.

The discharge period was set to 70.6 μs for the intermediate coating region 103, and the coating resolution in the relative movement direction of the substrate and the inkjet head was set to 3000 dpi. In contrast, the discharge period was changed to 235.2 us for the innermost peripheral coating region 102 and the outermost peripheral coating region 104, and the coating resolution was changed to 900 dpi.

TABLE 1

| | | | | | Build-up | | | Build-up | |
|---|---|---|---|---|---|---|---|---|---|
| | | | | | at | | | at | |
| | | | | | peripheral | | | outer | |
| | Drop amount | Drop amount | Drop amount | Drop amount | inner | | Drop amount | peripheral | |
| Condition | in region 102 | in region 103 | in region 104 | ratio, regions | end face | | ratio, regions | end face | |
| number | (L/m²) | (L/m²) | (L/m²) | 102 and 103 | (μm) | | 104 and 103 | (μm) | |
| 1 | 16.2 | 16.2 | 16.2 | 1.0 | 5.2 | X | 1.0 | 4.9 | X |
| 2 | 14.6 | 16.2 | 14.6 | 0.9 | 3.1 | X | 0.9 | 2.5 | X |
| 3 | 13.0 | 16.2 | 13.0 | 0.8 | 1.3 | X | 0.8 | 1.1 | X |
| 4 | 11.3 | 16.2 | 11.3 | 0.7 | 0.2 | ◯ | 0.7 | −0.1 | ◯ |
| 5 | 9.7 | 16.2 | 9.7 | 0.6 | −0.9 | ◯ | 0.6 | −1.0 | ◯ |
| 6 | 8.1 | 16.2 | 8.1 | 0.5 | −2.1 | X | 0.5 | −2.4 | X |
| 7 | 6.5 | 16.2 | 6.5 | 0.4 | −3.0 | X | 0.4 | −3.2 | X |
| 8 | 4.9 | 16.2 | 4.9 | 0.3 | −4.3 | X | 0.3 | −4.3 | X |

As shown in Table 1, the following results were obtained when the drop amount ratio between the innermost peripheral coating region 102 and its adjacent region (the intermediate coating region 103), and the drop amount ratio between the outermost peripheral coating region 104 and its adjacent region (the intermediate coating region 103) were between 0.6 and about 0.7. More specifically, in condition number 4 (ratio 0.7) and condition number 5 (ratio 0.6), the thickness difference was within ±1 μm with respect to the average thickness near a radius of 40 mm.

Thus, it was found that there is less build-up at the coating end face when the amount of resin dropped per unit of surface area in the innermost peripheral region or the outermost peripheral region is reduced with respect to the adjacent coating region.

Furthermore, it was found that the coating end face ends up being concave if the amount of resin dropped per unit of surface area in the innermost peripheral region or the outermost peripheral region is reduced too much.

In this working example, the change in the amount of resin dropped per unit of surface area was achieved by changing the discharge period, but how the dropped amount is changed is not limited to this. The drop amount may be reduced by leaving the discharge period constant and changing the signal amplitude of the multipulse pattern inputted to the inkjet head, or the number of pulses of the multipulse pattern may be varied.

Also, a piezo head in which the resin was pushed out by a piezoelectric element was used as the inkjet head in this working example, but a thermal head may be used instead, in which the resin is pushed out by a heater.

Next, the first resin intermediate layer 604 was formed under the conditions of condition number 4 in Table 1, after which the second resin intermediate layer 607 was formed by going through an information face transfer step and then a step of forming the second information layer 606.

The build-up at the coating end face in the formation of the second resin intermediate layer 607 was evaluated under the same conditions as in the formation of the first resin intermediate layer 604 above. The drop amount per unit of surface area was varied in three regions partitioned into concentric circles in the innermost peripheral coating region 102, the intermediate coating region 103, and the outermost peripheral coating region 104.

Here again, an experiment was conducted in which the coating resolution perpendicular to the relative movement direction of the substrate and the inkjet head was 600 dpi, the coating resolution in the relative movement direction of the substrate and the inkjet head was varied by changing the discharge period, and the resin drop amount per unit of surface area was changed. Table 2 shows the results of this experiment. Condition numbers 4 and 5 are working examples pertaining to the present invention, while condition numbers 1 to 3 and condition number 6 are comparative examples.

TABLE 2

| | | | | | Build-up | | | Build-up | |
|---|---|---|---|---|---|---|---|---|---|
| | | | | | at | | | at | |
| | | | | | inner | | | outer | |
| | Drop amount | Drop amount | Drop amount | Drop amount | peripheral | | Drop amount | peripheral | |
| Condition | in region 102 | in region 103 | in region 104 | ratio, regions | end face | | ratio, regions | end face | |
| number | (L/m²) | (L/m²) | (L/m²) | 102 and 103 | (μm) | | 104 and 103 | (μm) | |
| 1 | 11.3 | 11.3 | 11.3 | 1.0 | 4.1 | X | 1.0 | 3.8 | X |
| 2 | 9.7 | 11.3 | 9.7 | 0.9 | 2.6 | X | 0.9 | 2.3 | X |
| 3 | 8.1 | 11.3 | 8.1 | 0.7 | 1.4 | X | 0.7 | 1.3 | X |
| 4 | 6.5 | 11.3 | 6.5 | 0.6 | 0.2 | ◯ | 0.6 | 0.1 | ◯ |
| 5 | 4.9 | 11.3 | 4.9 | 0.4 | −0.8 | ◯ | 0.4 | −0.8 | ◯ |
| 6 | 3.2 | 11.3 | 3.2 | 0.3 | −1.6 | X | 0.3 | −1.8 | X |

As shown in Table 2, the following results were obtained when the drop amount ratio between the innermost peripheral coating region 102 and its adjacent region (the intermediate coating region 103), and the drop amount ratio between the outermost peripheral coating region 104 and its adjacent region (the intermediate coating region 103) were between 0.4 and about 0.6. More specifically, in condition number 4 (ratio 0.6) and condition number 5 (ratio 0.4), the thickness difference was within ±1 μm with respect to the average thickness near a radius of 40 mm. Thus, it was found that there is less build-up at the coating end face when the amount of resin dropped per unit of surface area in the innermost peripheral region or the outermost peripheral region is reduced with respect to the adjacent coating region.

It was also found that the thickness standard was met under conditions when the drop amount ratio was lower with the second resin intermediate layer 607 as compared to the results of Table 1 in which the first resin intermediate layer 604 was formed.

The reason is as follows as to why unfavorable results were obtained with condition number 3 (ratio 0.7) in Table 2 despite the fact that condition number 3 (ratio 0.7) in Table 2 had the same ratio as condition number 4 (ratio 0.7) in Table 1. Since the molded resin substrate 601 was coated with the first resin intermediate layer 604, build-up was less likely to be large, whereas since the first resin intermediate layer 604 was coated with the second resin intermediate layer 607, build-up was more likely to be large. Accordingly, with the first resin intermediate layer 604, the drop amount ratio between the intermediate coating region 103 and the innermost peripheral coating region 102 and outermost peripheral coating region 104 has to be set large. By contrast, with the second resin intermediate layer 607, the build-up will be too large if the drop amount ratio between the intermediate coating region 103 and the innermost peripheral coating region 102 and outermost peripheral coating region 104 is set large.

The above tells us that the ratio of the drop amount per unit of surface area for the plurality of resin layers of the resin intermediate layer is preferably larger (or at least the same) with the resin layers coating the substrate than with other resin layers.

The reason is as follows as to why build-up was more likely to occur at the end face with the second resin intermediate layer 607 than with the first resin intermediate layer 604. The first resin intermediate layer 604 was formed by dropping resin onto the molded resin substrate 601, but the second resin intermediate layer 607 was formed over the cured first resin intermediate layer 604. Although it depends on the properties of the resin material, in general, with a UV curing acrylic resin with a viscosity of about 10 mPa·s, the resin will separate more easily when dropped onto a cured UV curing acrylic resin than when dropped onto a polycarbonate substrate. Also, this creates a tendency for the build-up to be larger at the end face. Actually, when the drop amount per unit of surface area for the innermost peripheral coating region 102 and the drop amount per unit of surface area for the outermost peripheral coating region 104 are set to be the same with respect to the drop amount in the adjacent intermediate coating region 103 (condition number 1 in Table 1), the following result is obtained. The amount of build-up at the end face corresponds to approximately 25% with respect to the average thickness near a radius of 40 mm. Also, this amount is larger than the approximately 20% that is the amount of build-up at the end face with respect to the average thickness near a radius of 40 mm in the case of the first resin intermediate layer dropped onto the substrate (condition number 1 in Table 1).

Changing the drop amount per unit of surface area here was accomplished by changing the discharge period, but how the drop amount is changed is not limited to this. For instance, drop amount may be reduced by leaving the discharge period constant and changing the signal amplitude of the multipulse pattern inputted to the inkjet head, or the number of pulses of the multipulse pattern may be varied.

Also, a piezo head in which the resin was pushed out by a piezoelectric element was used as the inkjet head in this working example, but a thermal head may be used instead, in which the resin is pushed out by a heater.

### Working Example 2

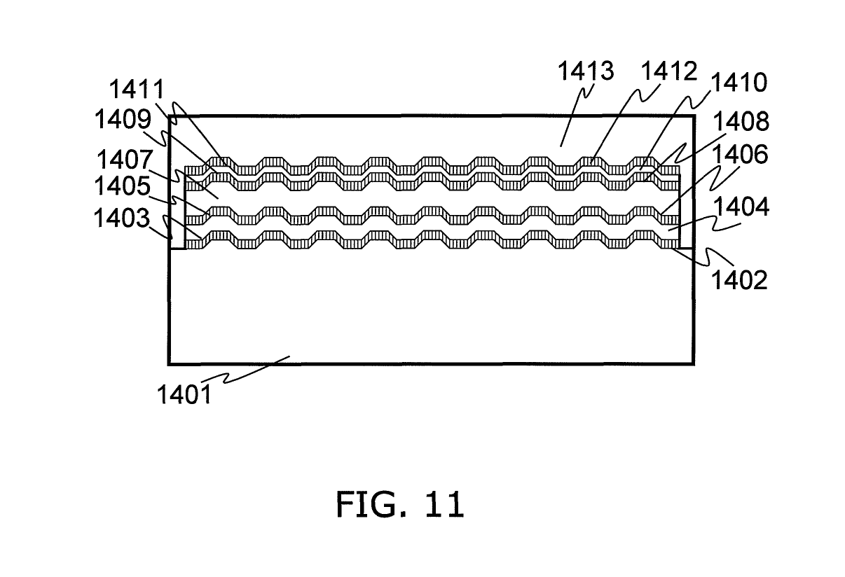

A four-layer information recording medium is shown in FIG. 11 as Embodiment 2 pertaining to the present invention.

This four-layer information recording medium has a molded resin substrate 1401, a first information layer 1403, a second information layer 1406, a third information layer 1409, a fourth information layer 1412, and a protective layer 1413. The four-layer information recording medium further has a first resin intermediate layer 1404, a second resin intermediate layer 1407, and a third resin intermediate layer 1410. The first information layer 1403, the second information layer 1406, the third information layer 1409, and the fourth information layer 1412 are composed of a thin-film material that allows thermal recording, or a metal thin film. The first resin intermediate layer 1404, the second resin intermediate layer 1407, the third information layer 1409, the third resin intermediate layer 1410, the fourth information layer 1412, and the protective layer 1413 are composed of a resin that is substantially transparent with respect to the recording and reproduction light.

A first information layer 1402 is formed in a bumpy shape over the molded resin substrate 1401. The first information layer 1403 is laminated over the first information face 1402. The first resin intermediate layer 1404 is formed over the first information layer 1403. A second information face 1405 is formed in a bumpy shape over the first resin intermediate layer 1404. The second information layer 1406 is laminated over the second information face 1405. A second resin intermediate layer 1407 is formed over the second information layer 1406. A third information face 1408 is formed in a bumpy shape over the second resin intermediate layer 1407. The third information layer 1409 is formed over the third information face 1408. The third resin intermediate layer 1410 is formed over the third information layer 1409. A fourth information face 1411 is formed in a bumpy shape over the third resin intermediate layer 1410. The fourth information layer 1412 is laminated over the fourth information face 1411. The protective layer 1413 covers the fourth information layer 1412.

The thicknesses of the first resin intermediate layer 1404, the second resin intermediate layer 1407, the third resin intermediate layer 1410, and the protective layer 1413 are set to 15 μm, 19 μm, 11 μm, and 55 μm, respectively.

### Working Example 2

An experiment was conducted into this four-layer information recording medium under the same conditions as in Working Example 1.

Table 3 shows the results of measuring build-up or depression at the coated end face and the resin drop amount per unit of surface area in each region in the formation of the first resin intermediate layer 1404. Condition numbers 2 and 3 are working examples pertaining to the present invention, while condition numbers 1 and 4 to 6 are comparative examples.

TABLE 3

| | | | | | Build-up | | | Build-up | |
|---|---|---|---|---|---|---|---|---|---|
| | | | | | at | | | at | |
| | | | | | inner | | | outer | |
| | Drop amount | Drop amount | Drop amount | Drop amount | peripheral | | Drop amount | peripheral | |
| Condition | in region 102 | in region 103 | in region 104 | ratio, regions | end face | | ratio, regions | end face | |
| number | (L/m²) | (L/m²) | (L/m²) | 102 and 103 | (μm) | | 104 and 103 | (μm) | |
| 1 | 9.4 | 9.4 | 9.4 | 1.0 | 2.4 | X | 1.0 | 2.3 | X |
| 2 | 8.5 | 9.4 | 8.5 | 0.9 | 0.7 | ◯ | 0.9 | 0.6 | ◯ |
| 3 | 7.5 | 9.4 | 7.5 | 0.8 | −0.1 | ◯ | 0.8 | −0.3 | ◯ |
| 4 | 6.6 | 9.4 | 6.6 | 0.7 | −1.2 | X | 0.7 | −1.3 | X |
| 5 | 5.6 | 9.4 | 5.6 | 0.6 | −1.8 | X | 0.6 | −2.0 | X |
| 6 | 4.7 | 9.4 | 4.7 | 0.5 | −2.5 | X | 0.5 | −2.8 | X |

As is clear from the table, under condition numbers 2 (ratio 0.9) and 3 (ratio 0.8), in which the drop amount ratio between the intermediate coating region 103 and the innermost peripheral coating region 102 and outermost peripheral coating region 104 was set relatively high, build-up or depression was sufficiently reduced at the inner peripheral end face and the outer peripheral end face. On the other hand, under condition number 1 (ratio 1.0), condition number 4 (ratio 0.7), condition number 5 (ratio 0.6), and condition number 6 (ratio 0.5), build-up or depression was too large at the inner peripheral end face and the outer peripheral end face. These are examples in which the drop amount ratios between the intermediate coating region 103 and the innermost peripheral coating region 102 and between the intermediate coating region 103 and the outermost peripheral coating region 104 were set even higher, or were set relatively low.

The reason as to why favorable results were obtained when the drop amount ratios between the intermediate coating region 103 and the innermost peripheral coating region 102 and between the intermediate coating region 103 and the outermost peripheral coating region 104 were set relative high is as follows. Since the molded resin substrate 1401 is coated with the first resin intermediate layer 1404, it is less likely that the build-up or depression will be large. Accordingly, the depression will be too large unless the drop amount ratios between the intermediate coating region 103 and the innermost peripheral coating region 102 and between the intermediate coating region 103 and the outermost peripheral coating region 104 are set relatively high.

Table 4 shows the results of measuring build-up or depression at the coated end face and the resin drop amount per unit of surface area in each region in the formation of the second resin intermediate layer 1407. Condition numbers 4 and 5 are working examples pertaining to the present invention, while condition numbers 1 to 3 and 6 are comparative examples.

TABLE 4

| | | | | | Build-up | | | Build-up | |
|---|---|---|---|---|---|---|---|---|---|
| | | | | | at | | | at | |
| | | | | | inner | | | outer | |
| | Drop amount | Drop amount | Drop amount | Drop amount | peripheral | | Drop amount | peripheral | |
| Condition | in region 102 | in region 103 | in region 104 | ratio, regions | end face | | ratio, regions | end face | |
| number | (L/m²) | (L/m²) | (L/m²) | 102 and 103 | (μm) | | 104 and 103 | (μm) | |
| 1 | 11.9 | 11.9 | 11.9 | 1.0 | 4.3 | X | 1.0 | 4.0 | X |
| 2 | 10.7 | 11.9 | 10.7 | 0.9 | 2.6 | X | 0.9 | 2.5 | X |
| 3 | 8.3 | 11.9 | 8.3 | 0.7 | 1.6 | X | 0.7 | 1.3 | X |
| 4 | 7.1 | 11.9 | 7.1 | 0.6 | 0.5 | ◯ | 0.6 | 0.5 | ◯ |
| 5 | 4.8 | 11.9 | 4.8 | 0.4 | −0.6 | ◯ | 0.4 | −0.7 | ◯ |
| 6 | 3.6 | 11.9 | 3.6 | 0.3 | −1.4 | X | 0.3 | −1.8 | X |

As is clear from the table, under condition numbers 4 (ratio 0.6) and 5 (ratio 0.4), build-up or depression was sufficiently reduced at the inner peripheral end face and the outer peripheral end face. These are examples in which the drop amount ratios between the intermediate coating region 103 and the innermost peripheral coating region 102, between the outermost peripheral coating region 104 and the intermediate coating region 103, and between the innermost peripheral coating region 102 and the outermost peripheral coating region 104 were set relatively low. On the other hand, under condition number 1 (ratio 1.0), condition number 2 (ratio 0.9), condition number 3 (ratio 0.7), and condition number 6 (ratio 0.3), build-up or depression was too large at the inner peripheral end face and the outer peripheral end face. These are examples in which the drop amount ratios between the intermediate coating region 103 and the innermost peripheral coating region 102 and outermost peripheral coating region 104 were set even higher, or were set even lower.

It was also found that the thickness standard was met under conditions when the drop amount ratio was lower as compared to the results of Table 4 in which the first resin intermediate layer 1404 was formed.

The reason is as follows as to why unfavorable results were obtained despite the fact that condition number 2 (ratio 0.9) in Table 4 had the same ratio as condition number 2 (ratio 0.9) in Table 3. Since the molded resin substrate 1401 was coated with the first resin intermediate layer 1404, build-up was less likely to be large, whereas since the first resin intermediate layer 1404 was coated with the second resin intermediate layer 1407, build-up was more likely to be large. Accordingly, with the first resin intermediate layer 1404 the drop amount ratio between the intermediate coating region 103 and the innermost peripheral coating region 102 and outermost peripheral coating region 104 has to be set high. By contrast, with the second resin intermediate layer 1407, the build-up will be too large if the drop amount ratio between the intermediate coating region 103 and the innermost peripheral coating region 102 and outermost peripheral coating region 104 is set high.

The above tells us that the ratio of the drop amount per unit of surface area for the plurality of resin layers of the resin intermediate layer is preferably larger (or at least the same) with the resin layers coating the substrate than with other resin layers.

Table 5 shows the results of measuring build-up at the coated end face and the resin drop amount per unit of surface area in each region in the formation of the third resin intermediate layer 1410. Condition numbers 3 and 4 are working examples pertaining to the present invention, while condition numbers 1, 2, 5, and 6 are comparative examples.

TABLE 5

| | | | | | Build-up | | | Build-up | |
|---|---|---|---|---|---|---|---|---|---|
| | | | | | at | | | at | |
| | | | | | inner | | | outer | |
| | Drop amount | Drop amount | Drop amount | Drop amount | peripheral | | Drop amount | peripheral | |
| Condition | in region 102 | in region 103 | in region 104 | ratio, regions | end face | | ratio, regions | end face | |
| number | (L/m²) | (L/m²) | (L/m²) | 102 and 103 | (μm) | | 104 and 103 | (μm) | |
| 1 | 6.9 | 6.9 | 6.9 | 1.0 | 3.0 | X | 1.0 | 3.3 | X |
| 2 | 6.2 | 6.9 | 6.2 | 0.9 | 2.3 | X | 0.9 | 2.1 | X |
| 3 | 5.5 | 6.9 | 5.5 | 0.8 | 0.8 | ◯ | 0.8 | 0.5 | ◯ |
| 4 | 4.8 | 6.9 | 4.8 | 0.7 | −0.6 | ◯ | 0.7 | −0.6 | ◯ |
| 5 | 4.1 | 6.9 | 4.1 | 0.6 | −1.6 | X | 0.6 | −1.8 | X |
| 6 | 2.8 | 6.9 | 2.8 | 0.4 | −2.6 | X | 0.4 | −2.7 | X |

As is clear from the table, under condition numbers 3 (ratio 0.8) and 4 (ratio 0.7), build-up or depression was sufficiently reduced at the inner peripheral end face and the outer peripheral end face. These are examples in which the drop amount ratios between the intermediate coating region 103 and the innermost peripheral coating region 102 and outermost peripheral coating region 104 were set to a medium level. On the other hand, under condition number 1 (ratio 1.0), condition number 2 (ratio 0.9), condition number 5 (ratio 0.6), and condition number 6 (ratio 0.4), build-up or depression was too large at the inner peripheral end face and the outer peripheral end face. These are examples in which the drop amount ratios between the intermediate coating region 103 and the innermost peripheral coating region 102 and outermost peripheral coating region 104 were set even higher, or were set even lower.

It was also found that the thickness standard was met under conditions when the drop amount ratio was lower as compared to the results of Table 3 in which the first resin intermediate layer 1404 was formed, and that the thickness standard was met under conditions when the drop amount ratio was higher as compared to the results of Table 4 in which the second resin intermediate layer 1407 was formed.

The reason why unfavorable results were obtained with condition number 2 (ratio 0.9) in Table 5 despite the fact that condition number 2 (ratio 0.9) in Table 5 had the same ratio as condition number 2 (ratio 0.9) in Table 3 is as discussed in the explanation of Table 4.

The reason is as follows as to why unfavorable results were obtained despite the fact that condition number 5 (ratio 0.6) and condition number (ratio 0.4) in Table 5 had the same ratio as condition number 4 (ratio 0.6) and condition number 6 (ratio 0.4) in Table 4. Since the second resin intermediate layer 1407 was thick (with a thickness of 19 μm), build-up was more likely to be large at the coated end face, whereas since the third resin intermediate layer 1410 was thin (with a thickness of 11 μm), build-up was less likely to be large at the coated end face. Accordingly, with the second resin intermediate layer 1407 the drop amount ratio between the intermediate coating region 103 and the innermost peripheral coating region 102 and outermost peripheral coating region 104 has to be set low. By contrast, with the third resin intermediate layer 1410, the depression at the coated end face will be too large if the drop amount ratio between the intermediate coating region 103 and the innermost peripheral coating region 102 and outermost peripheral coating region 104 is set low.

Because of this, the drop amount ratios per unit of surface area for a plurality of resin layers is preferably varied according to the thickness of the plurality of resin layers, and more specifically, it was found that the greater is the thickness, the better it is to lower the ratio.

### Other Embodiments

Embodiments of the present invention will described above, but the present invention is not limited to the above-mentioned embodiments, and various modifications are possible without departing from the gist of the invention.

In the above embodiments, the coating of the intermediate region between the outermost peripheral coating region and the innermost peripheral coating region was all performed under the same conditions, but the present invention is not limited to this. For example, the intermediate coating region may be further divided into a plurality of regions, and the coating conditions made different for each one.

In the above embodiments, the outermost peripheral coating region, the innermost peripheral coating region, and the intermediate coating region were formed as concentric circles, but the present invention is not limited to this. For example, as long as each region is annular in shape, the edges of the regions need not be circular.

### INDUSTRIAL APPLICABILITY

The inkjet coating method of the present invention is useful as a way to form resin layers such as resin intermediate layers in a multilayer information recording medium, and in particular can be used in the resin layer lamination process for Blu-ray Discs and the like.

1. A method for manufacturing an information recording medium produced by the lamination of a substrate, a plurality of information layers, and a plurality of resin layers of different thickness that separate the information layers,
wherein the resin layers are formed by an inkjet coating method in which a curable resin is discharged at the substrate while either the substrate or an inkjet head is moved relative to the other,
the inkjet coating is performed in a coating pattern in which the amount of resin dropped onto the substrate per unit of surface area varies for each of the regions that are aligned in the radial direction of the substrate, and
of the coating regions, the amount of resin dropped per unit of surface area in the innermost peripheral region and/or the outermost peripheral region is less than the amount of resin dropped per unit of surface area in an adjacent coating region that is adjacent to the innermost peripheral region and/or the outermost peripheral region.

2. The method for manufacturing an information recording medium according to claim 1, wherein the ratio of the amount of resin dropped per unit of surface area in the innermost peripheral region and/or the outermost peripheral region to the amount of resin dropped per unit of surface area in the adjacent coating region in the resin layer applied adjacent to the substrate is same as or greater than the ratio in the resin layers applied over said resin layer.

3. The method for manufacturing an information recording medium according to claim 2, wherein the ratio is changed according to the thickness of the resin layers.

4. The method for manufacturing an information recording medium according to claim 1, wherein the amount of resin dropped per unit of surface area is varied by using either a method in which the amount of resin droplets discharged from the inkjet head is varied, or a method in which the coating resolution in the relative movement direction of the substrate with respect to the inkjet head, or a direction perpendicular to the relative movement direction, is varied.

5. The method for manufacturing an information recording medium according to claim 4, wherein the inkjet head has a structure with which the curable resin is discharged according to a signal pattern applied to the inkjet head, and the signal pattern is a multipulse pattern corresponding to a single droplet, and a pattern in which this multipulse pattern is repeated at a specific discharge period.

6. The method for manufacturing an information recording medium according to claim 5, wherein the droplet amount is changed by changing the pulse number of the multipulse pattern.

7. The method for manufacturing an information recording medium according to claim 5, wherein the droplet amount is changed by changing the pulse amplitude of the multipulse pattern.

8. The method for manufacturing an information recording medium according to claim 5, wherein the coating resolution is changed by changing the discharge period.

9. The method for manufacturing an information recording medium according to claim 5, wherein the inkjet head has a piezoelectric element, and the curable resin is discharged according to the signal pattern applied to the piezoelectric element.

10. The method for manufacturing an information recording medium according to claim 5, wherein the inkjet head has a heater, and the curable resin is discharged according to the signal pattern applied to the heater.

11. The method for manufacturing an information recording medium according to claim 1, wherein the discharge width of the curable resin with the inkjet head is at least the width of the substrate in a perpendicular relation to the travel direction of the inkjet head.

12. The method for manufacturing an information recording medium according to claim 1, wherein the curable resin is a radiation curable resin.

13. The method for manufacturing an information recording medium according to claim 12, wherein the radiation curable resin is a UV curable resin.
